(19) United States
(12) Patent Application Publication
(10) Pub. No.: US 2012/0153232 A1
(43) Pub. Date: Jun. 21, 2012

(54) THERMOPLASTIC MOLDING COMPOSITION

(75) Inventors: Cecile Gibon, Mannheim (FR); Xin Yang, Bensheim (DE); Christof Kujat, Neustadt (DE); Martin Weber, Maikammer (DE); Laszlo Szarvas, Ludwigshafen (DE); Daniel Klein, Mannheim (DE); Petra Poetschke, Dresden (DE); Beate Krause, Meissen (DE)

(73) Assignee: BASF SE, Ludwigshafen (DE)

(21) Appl. No.: 13/324,296

(22) Filed: Dec. 13, 2011

Related U.S. Application Data
(60) Provisional application No. 61/425,312, filed on Dec. 21, 2010.

(51) Int. Cl. H01B 1/24

(52) U.S. Cl. 252/506; 252/511

(57) ABSTRACT

The thermoplastic molding composition comprises, based on the thermoplastic molding composition,
a) as component A, at least one polyamide or copolyamide, or one polymer blend comprising polyamide,
b) as component B, from 3 to 20% by weight of carbon black or graphite, or a mixture thereof,
c) as component C, from 0.1 to 3% by weight of ionic liquids.

The invention relates to a thermoplastic molding composition which also comprises ionic liquids, alongside polyamide and carbon black or graphite or a mixture thereof.

The use of carbon black or graphite in specific plastics in combination with ionic liquids is known per se.

EP-A-2 223 904 relates to a process for producing antistatic synthetic stone for large-surface-area products. The synthetic stone comprises, alongside large proportions of inorganic materials, up to at most 40% by weight of a polymer matrix which comprises a polyurethane, epoxy resin, polyester resin, acrylate, methacrylate, and/or vinyl ester. Graphite or carbon black can be added to increase conductivity. The molding compositions also comprise ionic liquids.

EP-B-1 984 438 relates to an antistatic polyurethane which also comprises ionic liquids alongside fillers, such as carbon black.

WO 2008/006422 relates to the use of ionic liquids or solutions made of metal salts in ionic liquids as antistatic agents for plastics. The plastics here are in particular polyurethanes. No references are made to other plastics that can be used.

It is an object of the present invention to provide polyamide molding compositions which comprise carbon black or graphite or a mixture thereof and which have improved conductivity, or in which the content of carbon black or graphite or a mixture thereof can be reduced with retention of conductivity.

The invention achieves the object via a thermoplastic molding composition, comprising, based on the thermoplastic molding composition
a) as component A, at least one polyamide or copolyamide, or one polymer blend comprising polyamide,
b) as component B, from 3 to 20% by weight of carbon black or graphite, or a mixture thereof,
c) as component C, from 0.1 to 3% by weight of ionic liquids.

In the invention, it has been found that a combination of small amounts of ionic liquids with carbon black or graphite or a mixture thereof leads to a combined effect which brings about high conductivity even at low contents of carbon black or graphite or a mixture thereof.

The proportion of the ionic liquids in the thermoplastic molding composition here is preferably from 0.1 to 1.5% by weight, in particular from 0.3 to 1.2% by weight.

The proportion of carbon black or graphite or a mixture thereof as component B is preferably from 3.5 to 10% by weight, particularly preferably from 4 to 8% by weight, based on the thermoplastic molding composition.

### Ionic Liquid Component C

There is no restriction to specific ionic liquids as component C in the invention; it is possible to use any of the suitable ionic liquids, among which are also mixtures of various ionic liquids.

According to the definition of Wasserscheid and Keim in: Angewandte Chemie 2000, 112, 3926-3945, ionic liquids are salts which melt at relatively low temperatures and which have ionic, rather than molecular, character. Even at relatively low temperatures, they are liquid with relatively low viscosity. They are very good solvents for a large number of organic, inorganic, and polymeric substances. They are moreover generally incombustible and non-corrosive, and they have no measurable vapor pressure.

Ionic liquids are compounds which are formed from positive and negative ions, but which have no net charge. The positive ions, and also the negative ions, are predominantly monovalent, but it is also possible to use polyvalent anions and/or cations, for example having from one to five electronic charges per ion, preferably from one to four, more preferably from one to three, and very particularly preferably from one to two. The location of the charges can be at various localized or delocalized regions within a molecule, and their distribution can therefore be like that in a betaine, or else like that of a separate anion and cation. Preference is given to ionic liquids which are composed of at least one cation and of at least one anion.

Ionic liquids have more complex solution behavior than traditional aqueous and organic solvents, since ionic liquids are salts, rather than molecular nonionic solvents. It is preferable that ionic liquids are liquid in the temperature range from −70 to 300° C.

Preference is given to ionic liquids with lowest possible melting point, in particular below 150° C., more preferably below 100° C., particularly preferably below 80° C.

The ionic liquid functioning as means for improving conductivity can be selected in such a way that it is substantially chemically inert to the substances participating in the compounding process.

The ionic liquids are typically composed of an organic cation which is frequently obtained via alkylation of a compound, for example of imidazoles, pyrazoles, thiazoles, isothiazoles, azathiazoles, oxothiazoles, oxazines, oxazolines, oxazaboroles, dithiozoles, triazoles, selenozoles, oxaphospholes, pyrroles, boroles, furans, thiophenes, phospholes, pentazoles, indoles, indolines, oxazoles, isoxazoles, isotriazoles, tetrazoles, benzofurans, di benzofurans, benzothiophenes, dibenzothiophenes, thiadiazoles, pyridines, pyrimidines, pyrazines, pyridazines, piperazines, piperidines, morpholones, pyrans, anolines, morpholines, anilines, phthalazines, quinazolines, quinoxalines, and combinations thereof.

It is particularly preferable that the cation of the ionic liquid has been selected from the group consisting of quaternary ammonium cations, phosphonium cations, imidazolium cations, H-pyrazolium cations, pyridazinium ions, pyrimidinium ions, pyrazinium ions, pyrrolidinium cations, guanidinium cations, 5- to at least 6-membered cations which comprise at least one phosphorus or sulfur atom, the 1,8-diazabicyclo[5.4.0]undec-7-enium cation and the 1,8-diazabicyclo[4.3.0]non-5-inium cation or -essium cation or else from oligo- and polymers which comprise these cations.

The anionic moiety of the ionic liquid can be composed or inorganic or organic anions. Typical examples here are halides, BX₄⁻, PF₆⁻, AsF₆⁻, SbF₆⁻, NO₂⁻, NO₃⁻, SO₄²⁻, alkyl sulfate, BR₄⁻, substituted or unsubstituted carboranes, substituted or unsubstituted metallocarboranes, phosphates, phosphites, polyoxomethalates, substituted or unsubstituted carboxylates, triflates, triflimides, and non-coordinating anions. R here can be hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxyaryloxy, acyl, silyl, boryl, phosphino, amino, thio, seleno, and combinations thereof. X can mean halogen, in particular fluorine. By altering the combination of cations and anions it is possible to give the ionic liquid the desired solution properties for a specific thermoplastic polymer.

By way of example, the cation can have a single five-membered ring not bonded to other ring structures. An example here is an imidazolium cation. In this case, the anion of the ionic liquid can be a halogen or pseudohalogen. Reference can be made to US-A-2005 0288 484, paragraphs [0055] to [0062] for a more detailed description.

Room-temperature-ionic liquids which can be used in the invention are described by way of example on pages 13 to 16 of WO 02/079269, where cations given by way of example are large, asymmetric organic cations, such as N-alkylpyridinium, alkylammonium, alkylphosphonium, and N,N′-dialkylimidazolium. It is preferable that the ionic liquids have high stability and it is particularly preferable that they have a decomposition temperature of above 400° C. By way of example, dialkylimidazolium and alkylpyridinium have high decomposition temperatures of this type. It is particularly preferably possible here to use 1-alkyl-3-methylimidazolium salts, and an example of a suitable counterion here is PF₆⁻.

PCT/EP2007/060881, which has earlier priority than this application but is not a prior publication, describes other suitable ionic liquids.

Reference can be made to the following for more detailed descriptions of ionic liquids: Angew. Chem. 2000, 112, 3926 to 3945, K. N. Marsh et al., Fluid Phase Equilibria 219 (2004), 93 to 98, and J. G. Huddleston et al., Green Chemistry 2001, 3, 156 to 164 and also DE-A-102 02 838, WO 2005/019137, WO 2005/007657, WO 03/029329, WO 2004/084627, WO 2005/017001, and WO 2005/017252. By way of example, WO 2005/007657 describes salts of 1,5-diazabicyclo[4.3.0]non-5-ene (DBN) and 1,4-diazabicyclo[5.4.0]undec-7-ene (DBU). WO 2004/084627 describes by way of example, as cations, cyclic amine bases, such as pyridinium, pyridazinium, pyrimidinium, pyrazinium, imidazolium, pyrazolium, oxazolium, 1,2,3- and 1,2,4-triazolium, thiazolium, piperidinium, pyrrolidinium, quinolinium, and isoquinolinium. Examples of suitable counterions for 1,8-diazabicyclo[5.4.0]undec-7-enium (DBU) are chloride, methanesulfonate, formiate, acetate, tosylate, trifluoroacetate, saccharinate, hydrogensulfate, lactathiocyanate, and trifluoromethanesulfamate. The DBU ion can by way of example have substitution by C₁₋₁₂-alkyl radicals, in particular C₄₋₈-alkyl radicals. By way of example, 8-butyl-DBU or 8-octyl-DBU can be used as cation. Other suitable ionic liquids are described in WO 2008/006422, EP-A-2 223 904, WO 2009/101032, WO 2006/048171, JP-A-2009-155436, and JP-A-2005-220316.

The invention particularly preferably uses, as cation in the ionic liquid, optionally substituted imidazolium cations, optionally substituted 1,8-diazabicyclo[5.4.0]undec-7-enium cation, or a mixture thereof. Substituents that can be used are in particular alkyl substituents, such as C₁₋₁₀-alkyl substituents. Substituents that can be used with preference for imidazolium ions are C₁₋₄-alkyl substituents, in particular ethyl and methyl substituents. In this case it is particularly preferable to use, as cation, ethylmethylimidazolium (EMIM) or methylmethylimidazolium (MMIM). Another cation that can be used with preference is butylmethylimidazolium (BMIM). In the case of 1,8-diazabicyclo[5.4.0]undec-7-enium cation, it is preferable to use C₃₋₁₀-alkyl substituents, in particular C₄₋₈-alkyl substituents. Particular preference is given here to 8-butyl-DBU and 8-octyl-DBU, and also mixtures thereof.

The anions described above can be used as anions for the imidazolium salts. Preferred counterions are preferably those selected from halide, optionally substituted C₁₋₄-carboxylate, phosphate, C₁₋₄-alkyl phosphate, Di-C₁₋₄-alkyl phosphate, C₁₋₄-alkyl sulfate, C₁₋₄-alkylsulfonate, hydrogensulfate, triflimide, tetrafluoroborate, triflate, or a mixture thereof.

It is particularly preferable that the ionic liquid is ethylmethylimidazolium ethyl sulfate, or the corresponding triflimide, tetrafluoroborate, triflate or diethyl phosphate, or a mixture thereof.

The ionic liquid can also comprise relatively small proportions of water. By way of example, the water content in the ionic liquid can be from 0 to 5% by weight. It is preferable to minimize the water content.

The thermoplastic molding composition of the invention can also comprise, alongside components A, B, and C a metal salt mixed with or dissolved in component C. The metal salt here is preferably a metal salt soluble in the ionic liquid. Addition of the metal salts can achieve a further increase in conductivity. Suitable metal salts are described by way of example in EP-A-2 223 904. It is preferable that the metal salt is one selected from the group of the alkali metal salts of the following anions: bis(perfluoro-alkylsulfonyl)amide or bis(perfluoroalkylsulfonyl)imide, bis(trifluormethylsulfonyl)imide, alkyl- and aryl tosylates, perfluoroalkyl tosylates, nitrate, sulfate, hydrogensulfate, alkyl- and arylsulfonates, polyether sulfates and polyethersulfonates, perfluoroalkyl sulfates, sulfonates, alkyl- and arylsulfonates, perfluorinated alkyl- and arylsulfonates, alkyl and aryl carboxylates, perfluoroalkyl carboxylates, perchlorate, tetrachloroaluminate, saccharinate, thiocyanate, isothiocyanate, dicyanamide, tetraphenylborate, tetrakis(pentafluorophenyl)borate, tetrafluoroborate, hexafluorophosphate, phosphate, and/or polyether phosphate.

The proportion of metal salt is not comprised within the above quantitative data for component C.

If this type of metal salt is used concomitantly, the proportion thereof is preferably from 0 to 30% by weight, based on component C and depending on solubility.

For a combination of metal salts with ionic liquids, reference may be made to WO 2008/006422, in particular page 4, lines 6 to 11, and page 16.

### Polymer Component A

At least one polyamide or copolyamide or one polymer blend comprising polyamide is used as component A in the thermoplastic molding compositions of the invention.

The polyamides used in the invention are produced via reaction of starting monomers selected by way of example from dicarboxylic acids and diamines, or from salts made of the dicarboxylic acids and diamines, or from aminocarboxylic acids, aminonitriles, lactams, and mixtures thereof. Starting monomers for any desired polyamides can be involved here, examples being those for aliphatic, semiaromatic, or aromatic polyamides. The polyamides can be amorphous, crystalline, or semicrystalline. The polyamides can moreover have any desired viscosities and/or molecular weights. Particularly suitable polyamides have aliphatic, semicrystalline, or semiaromatic, or else amorphous structure of any type.

The intrinsic viscosity of these polyamides is generally from 90 to 350 ml/g, preferably from 110 to 240 ml/g, determined in a 0.5% strength by weight solution in 96% strength by weight sulfuric acid at 25° C. to ISO 307.

Semicrystalline or amorphous resins with molecular weight (weight average) at least 5000 are preferred, these being described by way of example in U.S. Pat. Nos. 2,071,250, 2,071,251, 2,130,523, 2,130,948, 2,241,322, 2,312,966, 2,512,606, and 3,393,210. Examples of these are polyamides which derive from lactams having from 7 to 11 ring members, e.g. polycaprolactam and polycapryllactam, and also polyamides which are obtained via reaction of dicarboxylic acids with diamines.

Dicarboxylic acids that can be used are alkanedicarboxylic acids having from 6 to 12, in particular from 6 to 10, carbon atoms, and aromatic dicarboxylic acids. Mention may be made here of the following acids: adipic acid, azelaic acid, sebacic acid, dodecanedioic acid (=decanedicarboxylic acid), and terephthalic and/or isophthalic acid.

Particularly suitable diamines are alkanediamines having from 2 to 12, in particular from 6 to 8, carbon atoms, and also m-xylylenediamine, di(a-aminophenyl)methane, di(4-aminocyclohexyl)methane, 2,2-di(aminophenyl)propane, or 2,2-di(4-aminocyclohexyl)propane, and also p-phenylenediamine.

Preferred polyamides are polyhexamethyleneadipamide (PA 66) and polyhexamethylenesebacamide (PA 610), polycaprolactam (PA 6), and also nylon-6/66 copolyamides, in particular having from 5 to 95% by weight content of caprolactam units. Particular preference is given to PA 6, PA 66, and nylon-6/66 copolyamides.

Mention may also be made of polyamides which are obtainable by way of example via condensation of 1,4-diaminobutane with adipic acid at elevated temperature (nylon-4,6). Production processes for polyamides having this structure are described by way of example in EP-A 38 094, EP-A 38 582, and EP-A 39 524.

Other examples are polyamides which are obtainable via copolymerization of two or more of the abovementioned monomers, or a mixture of two or more polyamides, in any desired mixing ratio.

Semiaromatic copolyamides, such as PA 6/6T and PA 66/6T, have moreover proven to be particularly advantageous, where the triamine content of these is less than 0.5% by weight, preferably less than 0.3% by weight (see EP-A 299 444). The low-triamine-content semiaromatic copolyamides can be produced by the processes described in EP-A 129 195 and 129 196. For semiaromatic polyamides, reference can moreover be made to WO 2008/074687.

The following non-exhaustive list comprises the polyamides mentioned, and also other polyamides for the purposes of the invention (the monomers being stated between parentheses):
PA 26 (ethylenediamine, adipic acid)
PA 210 (ethylenediamine, sebacic acid)
PA 46 (tetramethylenediamine, adipic acid)
PA 66 (hexamethylenediamine, adipic acid)
PA 69 (hexamethylenediamine, azelaic acid)
PA 610 (hexamethylenediamine, sebacic acid)
PA 612 (hexamethylenediamine, decanedicarboxylic acid)
PA 613 (hexamethylenediamine, undecanedicarboxylic acid)
PA 1212 (1,12-dodecanediamine, decanedicarboxylic acid)
PA 1313 (1,13-diaminotridecane, undecanedicarboxylic acid)
PA MXD6 (m-xylylenediamine, adipic acid)
PA TMDT (trimethylhexamethylenediamine, terephthalic acid)
PA 4 (pyrrolidone)
PA 6 (ε-caprolactam)
PA 7 (ethanolactam)
PA 8 (capryllactam)
PA 9 (9-aminononanoic acid)
PA11 (11-aminoundecanoic acid)
PA12 (laurolactam)
polyphenylenediamineterephthalamide (p-phenylenediamine, terephthalic acid).

These polyamides and production thereof are known. Details concerning their production are found by the person skilled in the art in Ullmanns Enzyklopädie der Technischen Chemie [Ullmann's Encyclopedia of Industrial Chemistry], 4th edition, vol. 19, pp. 39-54, Verlag Chemie, Weinmann 1980, and also Ullmann's Encyclopedia of Industrial Chemistry, vol. A21, pp. 179-206, VCH Verlag, Weinheim 1992, and also Stoeckhert, Kunststofflexikon [Plastics Encyclopedia], PP. 425-428, Hanser Verlag, Munich 1992 (keyword “Polyamide” [Polyamides] ff.).

It is particularly preferable to use nylon-6, nylon-66, or nylon-MXD6 (adipic acid/m-xylylenediamine).

It is moreover possible in the invention to provide functionalizing compounds in the polyamides, where these are capable of linkage to carboxy or amino groups and by way of example have at least one carboxy, hydroxy, or amino group. Compounds involved here are preferably

monomers which have branching effect, where these by way of example have at least three carboxy or amino groups,
monomers capable of linkage to carboxy or amino groups, e.g. via epoxy, hydroxy, isocyanato, amino, and/or carboxy groups, and which have functional groups selected from hydroxy groups, ether groups, ester groups, amide groups, imine groups, imide groups, halogen groups, cyano groups, and nitro groups, C—C double bonds, or C—C triple bonds,
or polymer blocks capable of linkage to carboxy or amino groups, for example poly-p-aramide oligomers.

Use of the functionalizing compounds can adjust the property profile of the resultant polyamides freely within a wide range.

By way of example, triacetonediamine compounds can be used as functionalizing monomers. These preferably involve 4-amino-2,2,6,6-tetramethylpiperidine or 4-amino-1-alkyl-2,2,6,6-tetramethylpiperidine, where the alkyl group in these has from 1 to 18 carbon atoms or has been replaced by a benzyl group. The amount present of the triacetonediamine compound is preferably from 0.03 to 0.8 mol %, particularly preferably from 0.06 to 0.4 mol %, based in each case on 1 mole of amide group of the polyamide. Reference can be made to DE-A-44 13 177 for further details.

It is also possible to use, as further functionalizing monomers, the compounds usually used as regulators, examples being monocarboxylic acids and dicarboxylic acids. Reference can likewise be made to DE-A-44 13 177 for details.

Component A can also comprise at least one further blend polymer, alongside one or more polyamides or copolyamides. The proportion in the blend polymer here of component A is preferably from 0 to 60% by weight, particularly preferably from 0 to 50% by weight, in particular from 0 to 40% by weight. If the blend polymer is present, the minimum amount thereof is preferably 5% by weight, particularly preferably at least 10% by weight.

Blend polymers that can be used are by way of example natural or synthetic rubbers, acrylate rubbers, polyesters, polyolefins, polyurethanes and mixtures thereof, optionally in combination with a compatibilizer.

Synthetic rubbers that may be mentioned as useful are ethylene-propylene-diene rubber (EPDM), styrene-butadiene rubber (SBR), butadiene rubber (BR), nitrile rubber (NBR), hydrin rubber (ECO), and acrylate rubbers (ASA). Silicone rubbers, polyoxyalkylene rubbers, and other rubbers are also useful.

Thermoplastic elastomers that may be mentioned are thermoplastic polyurethane (TPU), styrene-butadiene-styrene block copolymers (SBS), styrene-isoprene-styrene block copolymers (SIS), styrene-ethylene-butylene-styrene block copolymers (SEBS), and styrene-ethylene-propylene-styrene block copolymers (SEPS).

It is also possible to use resins in the form of blend polymers, examples being urethane resins, acrylic resins, fluoro resins, silicone resins, imide resins, amidimide resins, epoxy resins, urea resins, alkyd resins, and melamine resin.

It is also possible to use ethylene copolymers in the form of blend polymer, for example copolymers made of ethylene and 1-octene, 1-butene, or propylene, as described in WO 2008/074687. The molar masses of these ethylene-α-olefin copolymers are preferably in the range from 10 000 to 500 000 g/mol, with preference from 15 000 to 400 000 g/mol (number-average molar mass). It is also possible to use homopolyolefins, such as polyethylene or polypropylene.

Reference can be made to EP-B-1 984 438, DE-A-10 2006 045 869 and EP-A-2 223 904 for suitable polyurethanes.

Paragraph [0028] of JP-A-2009-155436 lists other suitable thermoplastic resins.

### Component B

Component B used comprises (conductive) carbon black, graphite, or a mixture thereof. Suitable carbon blacks and graphites are known to the person skilled in the art.

The carbon black is in particular a conductive carbon black. Conductive carbon black used can comprise any familiar form of carbon black, and by way of example the commercially available product Ketjenblack 300 from Akzo is suitable.

Conductive carbon black can also be used for conductivity modification. Carbon black conducts electrons by virtue of graphite-type layers embedded within amorphous carbon (F. Camona, Ann. Chim. Fr. 13, 395 (1988)). The current is conducted within the aggregrates made of carbon black particles and between the aggregates, if the distances between the aggregates are sufficiently small. In order to achieve conductivity while minimizing the amount added, it is preferable to use carbon blacks having anisotropic structure (G. Wehner, Advances in Plastics Technology, APT 2005, Paper 11, Katowice 2005). In these carbon blacks, the primary particles form aggregates giving anisotropic structures, and the necessary distances between the carbon black particles for achieving conductivity in compounded materials are therefore achieved even at comparatively low loading (C. Van Bellingen, N. Probst, E. Grivei, Advances in Plastics Technology, APT 2005, Paper 13, Katowice 2005).

The oil absorption of suitable types of carbon black (measured to ASTM D2414-01) is by way of example 60 ml/100 g, preferably more than 90 ml/100 g. BET surface area of suitable products is more than 50 m²/g, preferably more than 60 m²/g (measured to ASTM D3037-89). There can be various functional groups on the surface of carbon black. Various processes can be used to produce the carbon blacks (G. Wehner, Advances in Plastics Technology, APT 2005, Paper 11, Katowice 2005).

It is also possible to use graphite as conductivity additive. The term “graphite” means a form of carbon as described by way of example in A. F. Holleman, E. Wiberg, “Lehrbuch der anorganischen Chemie” [Textbook of inorganic chemistry], 91st-100th edn., pp. 701-702. Graphite is composed of planar carbon layers mutually superposed. Graphite can be comminuted by grinding. Particle size is in the range from 0.01 μm to 1 mm, preferably in the range from 1 to 250 μm.

Carbon black and graphite are described by way of example in Donnet, J. B. et al., Carbon Black Science and Technology, second edition, Marcel Dekker, Inc., New York 1993. It is also possible to use conductive carbon black, which is based on carbon black having a highly ordered structure. This is described by way of example in DE-A-102 43 592, in particular [0028] to [0030], in EP-A-2 049 597, in particular page 17, lines 1 to 23, in DE-A-102 59 498, in particular in paragraphs [0136] to [0140], and also in EP-A-1 999 201, in particular page 3, lines 10 to 17.

The thermoplastic molding compositions of the invention can moreover comprise further additional materials, for example further fillers, e.g. glass fibers, stabilizers, oxidation retarders, agents to counteract decomposition by heat and decomposition by ultraviolet light, lubricants and mold-release agents, colorants, such as dyes and pigments, nucleating agents, plasticizers, etc. Amounts typically present of these further additional materials are from 0 to 50% by weight, preferably from 0 to 35% by weight. Reference may be made to WO 2008/074687, pages 31 to 37 for a more detailed description of possible additional materials.

The thermoplastic molding compositions of the invention are produced via extrusion processes at a temperature which is preferably in the range from 170 to 350° C., particularly preferably from 200 to 300° C.

By way of example, a process as described in DE-A-10 2007 029 008 can be used. Reference can also be made to WO 2009/000408 for the production process.

The production process preferably takes place in a corotating twin-screw extruder in which components B and C are introduced into component A.

Component B can be introduced as powder or in the form of a masterbatch into a thermoplastic molding composition. The introduction of the ionic liquid of component C can take place independently of the introduction of the conductive filler of component B, for example in the “hot feed” of the extruder. As an alternative, a masterbatch comprising component C can be used.

Known processes can be used for the further processing of the thermoplastic molding composition, an example being injection molding or compression molding.

The process of the invention permits the production of thermoplastic molding compositions filled with the carbon fillers of component B, with low energy cost and with good levels of dispersion.

By virtue of the production process of the invention, the thermoplastic molding compositions or moldings produced therefrom become antistatic or conductive. The term “antistatic” indicates volume resistivities of from 10⁹ to 10⁶ ohms cm. The term “conductive” indicates volume resistivities of less than 10⁶ ohms cm.

A possible theory is that conductive thermoplastic molding compositions can be obtained in particular when the concentration of component B is in the vicinity of the percolation concentration. At this concentration, a network made of carbon black particles (or graphite) is preferably formed within the polymer matrix. This means that the individual particles of carbon black or of graphite are in contact with one another within the polymer matrix, and that they thus form a continuous path through the material. The addition of ionic liquid can provide a further significant increase in conductivity here.

The thermoplastic molding compositions of the invention are in particular used to produce conductive moldings.

The invention also provides moldings made of the thermoplastic molding composition described above.

The examples below provide further explanation of the invention.

### EXAMPLES

The following starting materials were used to produce the thermoplastic molding composition:

### Thermoplastic Matrix:

A1: Nylon-6 with intrinsic viscosity (IV) 150 ml/g
A2: Polyethylene (LDPE) with MFR 0.75 g/10 min

### Conductive Filler:

B: Printex XE2B conductive carbon black from Evonik

### Ionic Liquids:

The ionic liquids used were:

C1: 1-Ethyl-3-methyl-imidazolium triflimide (CAS No. 174899-82-2)
C2: 1-Ethyl-3-methyl-imidazolium ethyl sulfate (CAS No. 342573-75-5)
C3: 1-Ethyl-3-methyl-imidazolium tetrafluoroborate (CAS No. 143314-16-3)
C4: 1-Ethyl-3-methyl-imidazolium triflate (CAS No. 145022-44-2)

### Characterization Methods:

The intrinsic viscosity of the polyamide IV was determined to ISO 307 in a 0.5% by weight solution in 96% by weight sulfuric acid at 25° C.

The MFR of polyethylene was determined to ISO 1133 at 190° C. under a load of 2.16 kg.

Electrical conductivity was measured in the form of volume conductivity, using a 4-point measurement system. For each sheet, the measurement was made on five specimens of dimensions 77×12×4 mm³ which had been sawn from hardened sheets. In order to achieve good contact between specimen and electrodes, four silver electrodes were directly painted onto the specimen by using a conductive silver paste (conductive silver paste 200 from Hans Wohlbring GmbH). The current source used was current source 225, the voltage measurement equipment used was Programmable Electrometer 617, and the current measurement equipment used was Multimeter 1000, in each case from Keithley Instruments.

The molding compositions were produced by first dry-mixing components A1 and B and then wetting them with component C, and introducing the mixture into a DSM 15 extruder for the compounding process. The conditions for the extrusion process were: melt temperature 270° C., rotation rate 80 rpm, and residence time 5 minutes. The specimens were then injection-molded for conductivity measurement, in the form of sheets with dimensions 30×30×1.27 mm³. The injection-molded sheets were produced in a 12 mL Xplor molding machine at melt temperature 270° C., mold temperature 80° C., injection pressure from 12 to 16 bar, and cycle time 15 seconds. Table 1 below collates the constitution of the molding compositions and the volume resistivity determined.

TABLE 1

| | | | | | | | Volume resistivity |
|---|---|---|---|---|---|---|---|
| | | % by wt. | | % by wt. | | % by wt. | [ohm*cm] |
| Ref. 1 | A1 | 96 | B | 4 | — | — | 7.20E+11 |
| Ref. 2 | A1 | 95 | B | 5 | — | — | 9.01E+11 |
| Ref. 3 | A1 | 94 | B | 6 | — | — | 7.83E+10 |
| Ref. 4 | A1 | 100 | — | — | — | — | 8.81E+13 |
| Inv. ex. 4 | A1 | 95 | B | 4 | C2 | 1 | 6.36E+10 |
| Inv. ex. 5 | A1 | 94 | B | 5 | C2 | 1 | 8.92E+05 |
| Inv. ex. 6 | A1 | 93 | B | 6 | C2 | 1 | 1.41E+04 |

Reference example 1 serves for comparison with inventive example 4. Reference example 2 serves for comparison with inventive example 5. Reference example 3 serves for comparison with inventive example 6. In every case, addition of the ionic liquid caused a marked reduction of volume resistivity.

Reference example 4 reflects pure polyamide.

1-11. (canceled)

12. A thermoplastic molding composition comprising, based on the thermoplastic molding composition,
a) as component A, at least one polyamide or copolyamide, or one polymer blend comprising polyamide,
b) as component B, from 3 to 20% by weight of carbon black or graphite, or a mixture thereof,
c) as component C, from 0.1 to 3% by weight of ionic liquids.

13. The thermoplastic molding composition according to claim 12, wherein the amount of component B comprised in the thermoplastic molding composition is from 3.5 to 10% by weight, based on the thermoplastic molding composition.

14. The thermoplastic molding composition according to claim 12, wherein the amount of component C comprised in the thermoplastic molding composition is from 0.1 to 1.5% by weight, based on the thermoplastic molding composition.

15. The thermoplastic molding composition according to claim 13, wherein the amount of component C comprised in the thermoplastic molding composition is from 0.1 to 1.5% by weight, based on the thermoplastic molding composition.

16. The thermoplastic molding composition according to claim 12, wherein the polyamides in component A have been selected from the following list, the starting monomers being stated between parentheses:
PA 26 (ethylenediamine, adipic acid)
PA 210 (ethylenediamine, sebacic acid)
PA 46 (tetramethylenediamine, adipic acid)
PA 66 (hexamethylenediamine, adipic acid)
PA 69 (hexamethylenediamine, azelaic acid)
PA 610 (hexamethylenediamine, sebacic acid)
PA 612 (hexamethylenediamine, decanedicarboxylic acid)
PA 613 (hexamethylenediamine, undecanedicarboxylic acid)
PA 1212 (1,12-dodecanediamine, decanedicarboxylic acid)
PA 1313 (1,13-diaminotridecane, undecanedicarboxylic acid)
PA MXD6 (m-xylylenediamine, adipic acid)
PA TMDT (trimethylhexamethylenediamine, terephthalic acid)
PA 4 (pyrrolidone)
PA 6 (ε-caprolactam)
PA 7 (ethanolactam)
PA 8 (capryllactam)
PA 9 (9-aminononanoic acid)
poly-p-phenylenediamineterephthalamide (phenylenediamine, terephthalic acid)
PA11 (11-aminoundecanoic acid)
PA12 (laurolactam)
or a mixture or copolymer thereof.

17. The thermoplastic molding composition according to claim 12, wherein component A comprises, as blend polymer, natural or synthetic rubbers, acrylate rubbers, polyesters, polyolefins, polyurethanes, or a mixture thereof, optionally in combination with a compatibilizer.

18. The thermoplastic molding composition according to claim 12, which also comprises a metal salt mixed with or dissolved in component C.

19. The thermoplastic molding composition according to claim 12, wherein the cation of the ionic liquid in component C has been selected from the group consisting of quaternary ammonium cations, phosphonium cations, imidazolium cations, H-pyrazolium cations, pyridazinium ions, pyrimidinium ions, pyrazinium ions, pyrrolidinium cations, guanidinium cations, 5- to at least 6-membered cations which comprise at least one phosphorus or sulfur atom, the 1,8-diazabicyclo[5.4.0]undec-7-enium cation and the 1,8-diazabicyclo[4.3.0]non-5-inium cation or else from oligo- and polymers which comprise these cations.

20. The thermoplastic molding composition according to claim 12, wherein the anion in the ionic liquid in component C has been selected from halide, optionally substituted C₁₋₄-carboxylate, phosphate, C1-4-alkyl phosphate, Di-C1-4-alkyl phosphate, C1-4-alkyl sulfate, C1-4-alkylsulfonate, hydrogensulfate, triflimide, tetrafluoroborate, triflate, or a mixture thereof.

21. The thermoplastic molding composition according to claim 19, wherein the anion in the ionic liquid in component C has been selected from halide, optionally substituted C1-4-carboxylate, phosphate, C1-4-alkyl phosphate, Di-C1-4-alkyl phosphate, C1-4-alkyl sulfate, C1-4-alkylsulfonate, hydrogensulfate, triflimide, tetrafluoroborate, triflate, or a mixture thereof.

22. A process for producing the thermoplastic molding compositions according to claim 12, which comprises introducing components B and C into component A in a corotating twin-screw extruder.

23. The process according to claim 22, wherein the extrusion process is carried out at a temperature in the range from 170 to 350° C.

24. A molding made of the thermoplastic molding composition according to claim 12.
